(19) United States
(12) Patent Application Publication
(10) Pub. No.: US 2018/0011919 A1
(43) Pub. Date: Jan. 11, 2018

(54) SYSTEMS AND METHOD FOR CLUSTERING ELECTRONIC DOCUMENTS

(71) Applicant: Kira Inc., Toronto (CA)

(72) Inventors: Robert Henry WARREN, Toronto (CA); Alexander Karl HUDEK, Toronto (CA)

(21) Appl. No.: 15/201,659

(22) Filed: Jul. 5, 2016

(51) Int. Cl. G06F 17/30

(52) U.S. Cl. CPC G06F 17/30598; G06F 17/30011

(57) ABSTRACT

A system and method for clustering electronic documents where the method includes identifying a plurality of electronic documents stored on a computer readable medium, determining by a computer processor a distance metric between each document in said plurality of electronic documents, and grouping by the computer processor one or more documents from said plurality of electronic documents into clusters based on a maximum permissible distance metric between documents within a cluster.

### TECHNICAL FIELD

The invention relates generally to document clustering methodologies; and more specifically to a method for sorting electronic documents into clusters based on distances metrics and feature analysis.

### BACKGROUND

Information stored in electronic documents is growing at an exponential pace each year, including paper documents which are being scanned or otherwise converted to electronic form with searchable text derived from well-known character recognition software algorithms. Electronic documents can also be generated and exist exclusively in electronic form using well known document processing, publishing and creation software packages. It is often useful to search through or review a substantial number of these documents, particularly in the legal field.

One example arises in due diligence projects where large numbers of documents often need to be sorted, characterized, summarized or otherwise processed in a meaningful way. Traditionally, law firms have used junior associates, temporary contract workers, or students to handle the initial pass through the voluminous collections of documents before more substantive review is conducted on a subset of documents or those flagged to be of particular interest.

More recently, a number of software tools have been developed, marketed and sold which attempt to assist in the review of these collections of documents. One task often handled by software is the characterization of documents. For example, tools exist which can scan document text for specific phrases to then group, or cluster, documents for characterization as a certain type. For example, documents could be scanned for the text “confidentiality agreement” within the first paragraph and the software tool would then cluster all these documents labeling them as Confidentiality Agreements. More sophisticated examples exist as well, for example scanning documents for a phrase such as “under the laws of the state of New York”, which may then characterize documents as requiring review by a New York qualified lawyer, with other jurisdictions similarly clustered. These tools help eliminate the need for the initial review of documents and provide for a level of automation in the early stages of large scale document review.

Prior art solutions have their limitations though. For example, the dependency on particular phrases or keywords to cluster the documents has its obvious limitations. Furthermore, the clustering capable from these example searches leads to a first order clustering only without any intelligence or flexibility built into clustering documents for later analysis or characterization. They are also heavily dependent on user-defined phrases or terms to search for, or in the alternative, phrases and keywords provided by the suppliers of the software.

Certain other prior art solutions do provide clustering of documents into certain types, but these are mainly designed around the frequency of particular words occurring in each document. For example, documents with the highest number of references to the term “patent” can be characterized as intellectual property related documents.

Certain other prior art solutions make use of “meta-data” elements attached to the documents as additional data with which to cluster the data. A limitation of this prior-art is that the meta-data must be available for the documents in order for the clustering to work effectively, which is not always possible.

There is a need in the art for improved document clustering methods and systems which may be capable of providing higher than first-order document clustering.

### SUMMARY OF THE INVENTION

In one embodiment of the invention, there is disclosed a method for clustering electronic documents including identifying a plurality of electronic documents stored on a computer readable medium, determining by a computer processor a distance metric between each document in the plurality of electronic documents, and grouping by the computer processor one or more documents from the plurality of electronic documents into clusters based on a maximum permissible distance metric between documents within a cluster.

In one aspect of this first embodiment, the step of determining a distance metric is agnostic to the literal content of each document.

In another aspect of this first embodiment, the step of determining a distance metric comprises determining the cumulative frequency of individual features between each document and comparing the cumulative feature frequencies of each pair of documents to arrive at the distance metric.

In another aspect of this first embodiment, the method further includes outputting cluster data to a computer readable medium and inspecting a single document within each cluster to categorize the cluster as a whole as containing a specific type of document.

In another aspect of this first embodiment, the inspecting is by a user or by a computer processor executing a categorization algorithm.

In another aspect of this first embodiment, the method further includes grouping clusters having only a single document based on the maximum permissible distance metric into a cluster of anomalous documents which do not conform to the maximum permissible distance metric.

In another aspect of this first embodiment, the cluster of anomalous documents is categorized as containing uncategorized documents and queued for individual categorization of each document within the cluster of anomalous documents.

In another aspect of this first embodiment, the cumulative feature frequency is based on a pre-determined subset of features in each electronic document.

In another aspect of this first embodiment, the pre-determined subset omits one or more features selected from the group consisting of document words, word syntax, word grammar and typographical standard to the subject matter of the plurality of documents.

In another aspect of this first embodiment, the omitted features are determined by the computer processor from a database of predefined omitted features stored on a computer readable medium.

According to a second embodiment of the invention, there is provided a system for carrying out the aforementioned method, where the system includes a computer readable medium having computer executable instructions stored thereon, which when executed by a computer processor identifies a plurality of electronic documents stored on a computer readable medium, determines a distance metric between each document in the plurality of electronic documents and groups one or more documents from the plurality of electronic documents into clusters based on a maximum permissible distance metric between documents within a cluster.

In one aspect of the second embodiment, the distance metric determination is agnostic to the literal content of each document.

In another aspect of the second embodiment, the determining of a distance metric comprises determining the cumulative frequency of individual features between each document and comparing the cumulative feature frequencies of each pair of documents to arrive at the distance metric.

In another aspect of the second embodiment, the computer executable instructions further include instructions for outputting cluster data to a computer readable medium for the purpose of inspecting a single document within each cluster to categorize the cluster as a whole as containing a specific type of document.

In another aspect of the second embodiment, the outputting of cluster data is in a format suitable for inspecting by a user or by a computer processor executing a categorization algorithm.

In another aspect of the second embodiment, the computer executable instructions further include instructions for grouping clusters having only a single document based on the maximum permissible distance metric into a cluster of anomalous documents which do not conform to the maximum permissible distance metric.

In another aspect of the second embodiment, the cluster of anomalous documents is categorized as containing uncategorized documents and queued for individual categorization of each document within the cluster of anomalous documents.

In another aspect of the second embodiment, the cumulative feature frequency is based on a pre-determined subset of feature in each electronic document.

In another aspect of the second embodiment, the pre-determined subset omits one or more features selected from the group consisting of document words, word syntax, word grammar and typographical standard to the subject matter of the plurality of documents

In another aspect of the second embodiment, the omitted features are determined by the computer processor from a database of predefined omitted features stored on a computer readable medium.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1A shows a representation of a plurality of electronic documents prior to be clustered by the method and system of the invention.

FIG. 1B shows a representation of electronic documents clustered following processing by the method and system of the invention.

FIGS. 2, 3, 4, 5 and 6 show various exemplary electronic documents for the purpose of illustrating one embodiment of the invention.

FIG. 7 is a word frequency distribution chart of the documents of FIGS. 2-6.

FIG. 8A shows a plurality of electronic documents.

FIG. 8B shows a clustering of the documents of FIG. 8A.

FIG. 9A shows a plurality of electronic documents relating to the same general subject matter.

FIG. 9B shows a clustering of the documents of FIG. 9A.

FIG. 10A shows a plurality of electronic documents and one way of handling anomalous documents after clustering.

FIG. 10B shows an alternative manner of handling anomalous documents.

### DETAILED DESCRIPTION OF THE INVENTION

Having summarized the invention above, certain exemplary and detailed embodiments will now be described.

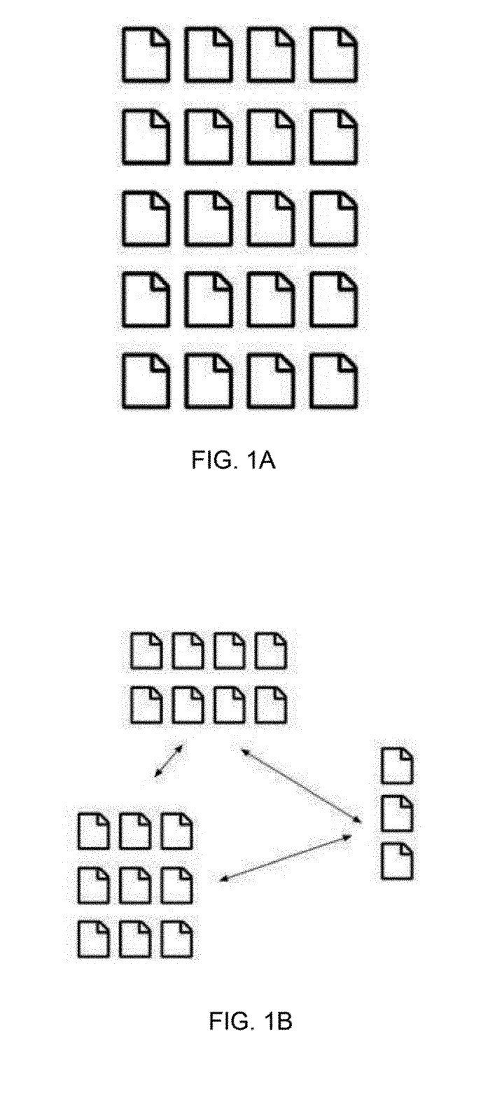

Referring now to FIG. 1A, there is shown a general representation of a plurality of electronic documents 10, the contents of which are unknown. One object of the invention is to provide the ability to segregate or cluster sub-groups of documents within the plurality of documents 10 without the need to define user requirements or require user intervention. A user will be able to identify documents that have similar content without having defined what makes the documents similar once the processing of the electronic document by the method or system of the invention has been completed. Throughout this description, reference is made to “electronic documents” and “documents” interchangeably. No distinction is be made between these two terms as the invention deal exclusively with electronic documents. Any reference to paper documents is with the understanding that these are converted to electronic documents prior to being processed by the method of the invention.

Broadly, in order to achieve this object, individual documents are clustered based on their contents using distance metrics between documents that be used to cluster the documents into groups. Each document is assessed to determine a unique vector representing the feature frequency of all features in the document. The distance metric is then obtained by taking the difference of the vectors of any two documents, resulting in a measure of the distance in similarity between any two documents meeting a threshold, or alternatively between each document and a reference document. In an alternative implementation, the distance metric may be obtained by comparing each document with a predetermined reference document and the distance metric defines the similarity of each document with the reference document. The documents are then grouped using only the computed distances between the sets of features within each document and documents that have a maximum distance between themselves are grouped in clusters. The term “feature” is used throughout this document to refer to features of text within the electronic documents. In the examples below, and in many practical applications, the feature refers to individual words within the documents. However, the invention is equally applicable and implementable with respect to features that make use of results from deep parsing of the text. These features include typography, grammar, syntax and combinations of these.

The distance metric is a dimensionless vector and clustering is based on the total features similarity between documents. Hence, clusters may be built from documents that only share similarity to each other but have no common features sets. This is thought to be a significant improvement over the prior art where documents are clustered based on having the same or very similar sentences, for example.

The averaged distances between all of the documents within each cluster group is used to provide a global distance between the groups of documents, thereby providing to the user a data point of the relative difference between each cluster of documents. The global distance is preferably obtained from subsequent processing to provide a user with a numerical representation of the range of differences between all documents in the set.

The output of the processing summarized above is show in FIG. 1B, where the electronic documents 10 of FIG. 1A are clustered into three (by way of example only) clusters 12, 14, and 16. Since the individual clusters are known to have distance metrics within a predetermined range, the documents within each cluster can be said to be similar documents. This would permit a user to review one, or only a few, documents within the cluster to determine (a) which clusters contain known document types; and (b) which clusters contain documents of an unknown type or anomalous documents. Alternatively, subsequent automated processing could be used to characterize each individual cluster; thereby reducing the computing resources required for downstream automation procedures.

The clustering method summarized above is unsupervised and accordingly does not require training or input from a user. Specifics of the invention will be described in more detail below with further examples used to illustrate the application of the invention.

Mathematically, the method seeks to assemble like documents while rejecting one off documents. Thus for any given document d it forms a cluster [symbol] ∀diεD: C(f(di)−f(d)<M)>minDocs where minDocs is the minimum number of documents within a cluster and M is the vector of the maximal distances between two features for them to be considered similar.

It will be understood by those of ordinary skill in the art that the embodiments described herein may be practiced without these specific details. In other instances, well-known methods, procedures and components have not been described in detail so as not to obscure the embodiments generally described herein. Furthermore, this description is not to be considered as limiting the scope of the embodiments described herein in any way, but rather as merely describing the implementation of various embodiments as presented here for illustration.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. In certain embodiments, the computer may be a digital or any analogue computer.

Program code is applied to input data to perform the functions described herein and to generate output information. The output information is applied to one or more output devices, in known fashion.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g., read-only memory (ROM), magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems and methods of the described embodiments are capable of being distributed in a computer program product including a physical, nontransitory computer readable medium that bears computer usable instructions for one or more processors. The medium may be provided in various forms, including one or more diskettes, compact disks, tapes, chips, magnetic and electronic storage media, and the like. Non-transitory computer-readable media comprise all computer-readable media, with the exception being a transitory, propagating signal. The term non-transitory is not intended to exclude computer readable media such as a volatile memory or random access memory (RAM), where the data stored thereon is only temporarily stored. The computer useable instructions may also be in various forms, including compiled and non-compiled code.

As a precursor to the steps involved in carrying out the invention, documents are imported into the system; or in the alternative, a computer storage device is scanned for electronic documents. Any hard copy documents are converted into an appropriate digital form, for example by scanning or creating a digital image. The digital form may be a commonly known file format. Converted documents are subject to an optical character recognition (‘OCR’) algorithm to convert them into true electronic documents.

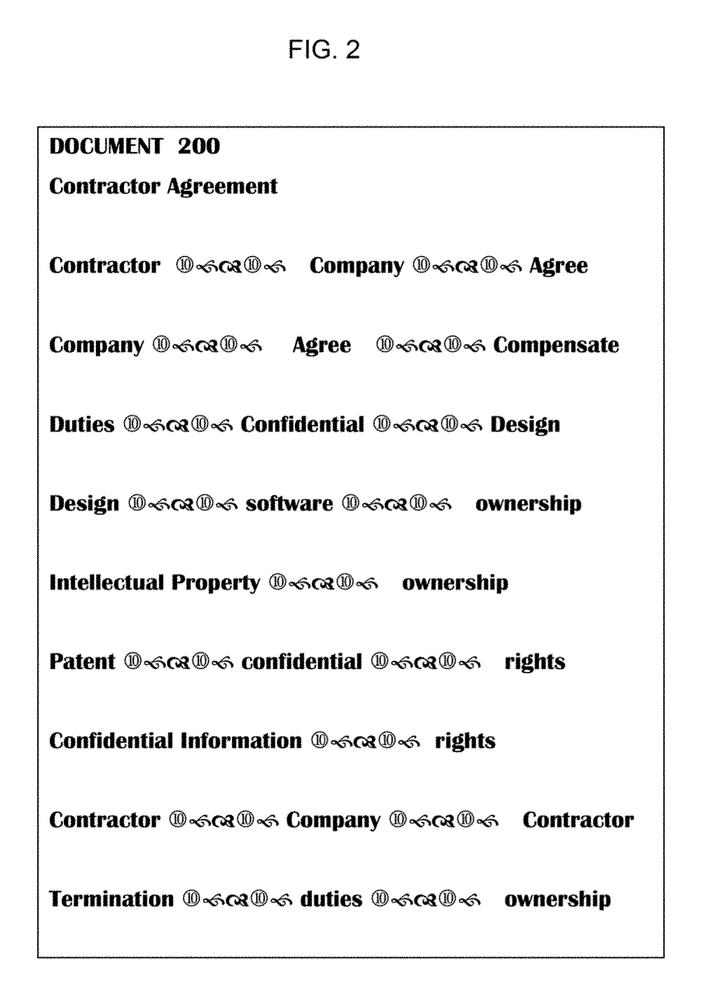

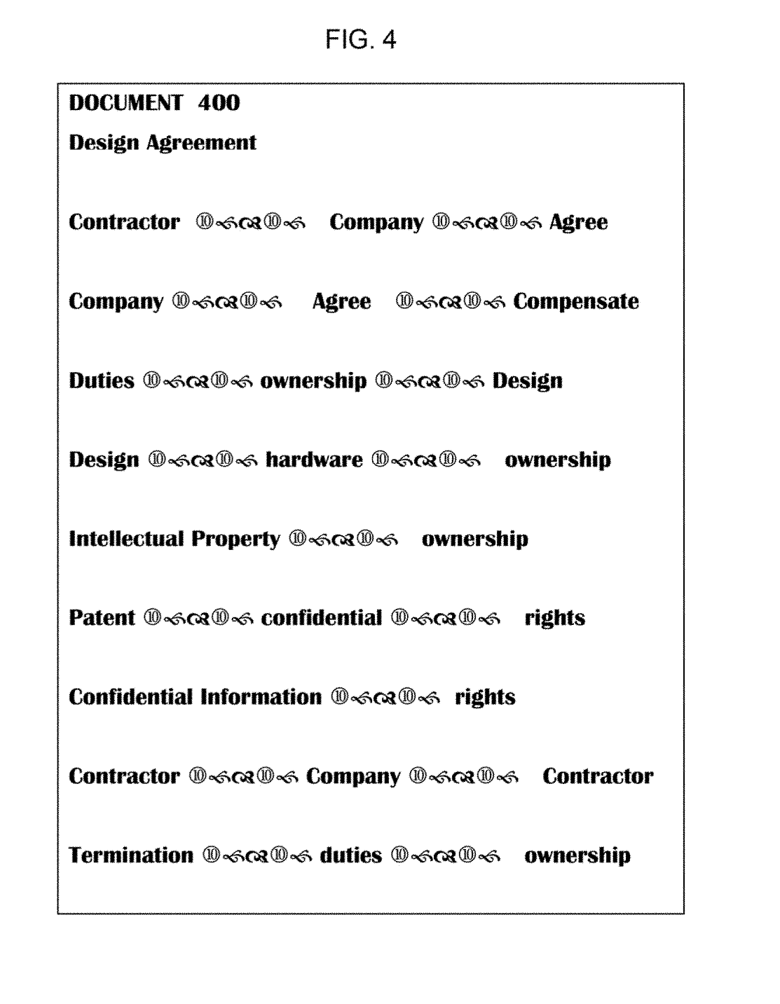

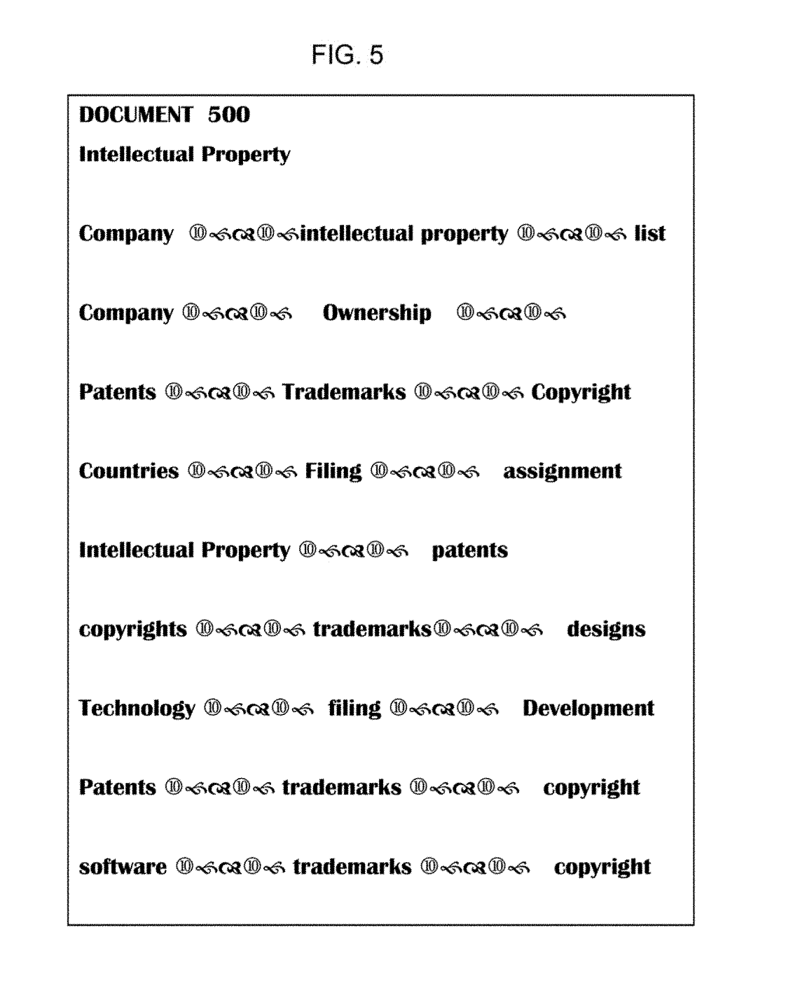

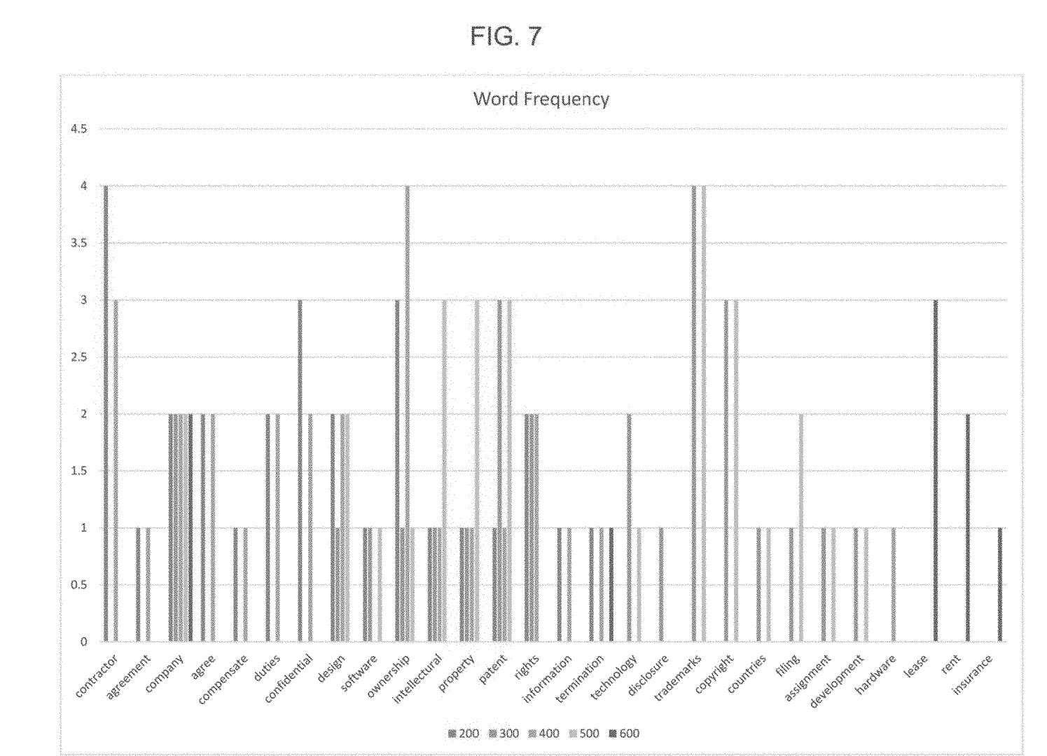

The documents are analyzed to arrive at a distance metric for each document. In one simplified embodiment, the determining of a distance metric may be determined with reference to the documents shown in FIGS. 2 to 6, where documents 200, 300, 400, 500 and 600, are assessed to determine their cumulative feature frequency. The documents 200, 300, 400, 500 and 600 are simplified for illustrative purposes. The text shown in the “wing-dings” font is meant to represent additional text in the sentence structure that is omitted for this example for ease of understanding; however, as will be noted further below it is possible to explicitly omit certain text from the analysis. A graphical representation of the cumulative feature frequency in each document is shown in FIG. 7. The computer representation of the graphical representation in FIG. 7 is a vector containing the each of the individual features from the set of all features in all documents and their frequencies. Specifically, the vector for each document would be [x₁, x₂, . . . xₖ], where xᵢ is the number of times the feature i appears in the document and k is the total number of unique features across each document. The distance metric would then be obtained by taking a vector inner product of each document with respect to every other document and arriving at a distance metric for any two documents.

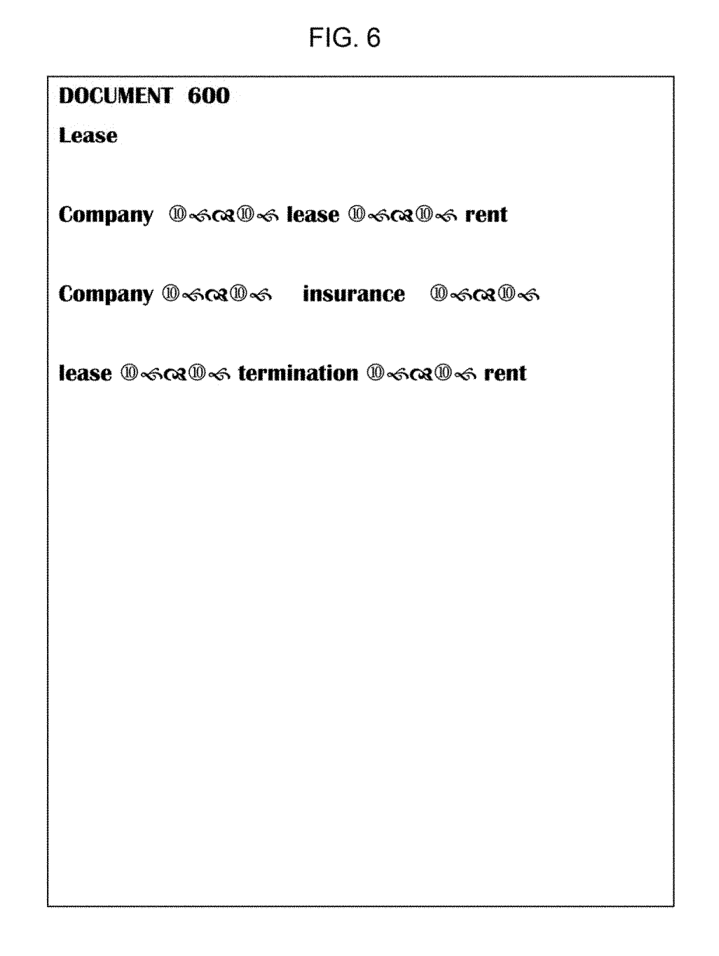

For example, with respect to the feature frequency results in FIG. 6, the distance metric between each pair of documents can be represented summarily in Table 1, which shows values used for illustrative purposes only:

TABLE 1

| | 200 | 300 | 400 | 500 | 600 |
|---|---|---|---|---|---|
| 200 | 1 | 8 | 2 | 10 | 35 |
| 300 | 8 | 1 | 6.2 | 1.2 | 27 |
| 400 | 2 | 6 | 1 | 8 | 33 |
| 500 | 10 | 2 | 8 | 1 | 25 |
| 600 | 35 | 27 | 33 | 25 | 1 |

With this analysis, documents 200 and 400 could be clustered together and documents 300 and 500 falling into a different cluster. Document 600 would be clustered on its own and characterized as an anomalous document. One skilled in the art could see how these results could be extrapolated over a very large number of documents, with a cluster of anomalous documents containing those with a wide range of distance metrics. The clustering turns out to be accurate as documents 200 and 400 are both contractor-type agreements where an individual is hired to design a particular product. Documents 300 and 500 are both documents which list or identify items relating to the technology or intellectual property owned by a company. Finally, document 600 is held to be anomalous and on closer inspection is indeed so as it is a lease agreement. Although, it should be noted that this assessment of whether the clustering is accurate or not is described for illustrative purposes only. In practice, the system is entirely agnostic to the specifics of the documents in each cluster and makes no assessment of the meaning of features, terms, sentences or other language structures in the documents themselves, either along or within the cluster. The further processing of each of the clusters is described in more detail below.

From the data in Table 1, it becomes possible to generate certain statistical data that can be used to provide additional information regarding the collection of documents in the dataset. For example, the average distance between documents within a given cluster can be used to determine the closeness of similarity of documents within each clusters. In addition, a global average distance can be generated to provide an indication of how similar all documents within the dataset are. With this information, it becomes possible to permit users to determine the maximum distance metric between documents to permit documents within the same cluster and to re-run the algorithm, if appropriate.

Note that this analysis turns out to be successful even where the documents have altogether different titles or headings, and is independent of the sentence structure or groupings of features. This could be useful where documents are drafted in different ways or using different language preferences. It turns out to be even more useful where translations of documents are used, especially machine-language translations. These translations often create slightly mangled sentence structures and applying the invention in this manner would result in the translated documents being clustered correctly as well.

In another aspect, the cumulative feature frequency could be built around a knowledge base of features known or otherwise determined to be similar. For example, a database of similar features could be implemented or built-up over time to, for example, eliminate treating features such as “agreement” and “contract” differently. Further adaptations could also be implemented for typographical errors such that features having predetermined commonalities with each other are considered to be the same feature for the purpose of creating the clusters.

Preferably, overly common features are excluded from the analysis. These would typically be pronouns and adjectives, but could also extend to other features common to many types of legal documents. In this regard, the ability to specifically exclude features from the vector generation is an option that may be provided to the user. The result is that only features clearly relevant to the core content of individual documents are used to generate the distance metric. Of course, this result could also possibly be achieved by comparing the outcome of the feature frequency determination and eliminating features which are found to be overly common across all or most documents.

Clusters may additionally created using the contents of specific legal provisions previously identified within each of the documents. This is desirable as the clustering algorithm then behaves as an outlier detection mechanism which locates documents whose specific legal clauses have been modified from a standard contractual clause.

It is also contemplated that the clustering could focus on certain portions of documents only, to the exclusion of others. In one variation, the clustering is applied to headers within documents only so that the output clusters are those who have similarities in their section headings, even if these headings use altogether feature groups. There are a number of ways in which headings can be identified as such, including seeking out text in a different font, text with a minimum spacing before and after the line that text is on. Prior art methods of identifying headings in documents are known.

One example of the clustering based on headings is shown in FIGS. 7A and 7B. FIG. 7A shows a plurality of documents 202. Only certain text is shown in the figures for the purposes of illustration. An algorithm would first be applied which seeks to identify the headings in the document; and subsequently the clustering method as described above is applied. The result is the four clusters of FIG. 7B. In this example, documents are clustered into clusters 204, 206, 208 and 210. Cluster 210 contains only a single anomalous document without a readily identifiable header. Each of the other clusters have documents with similar headers, although the header text does differ in some instances.

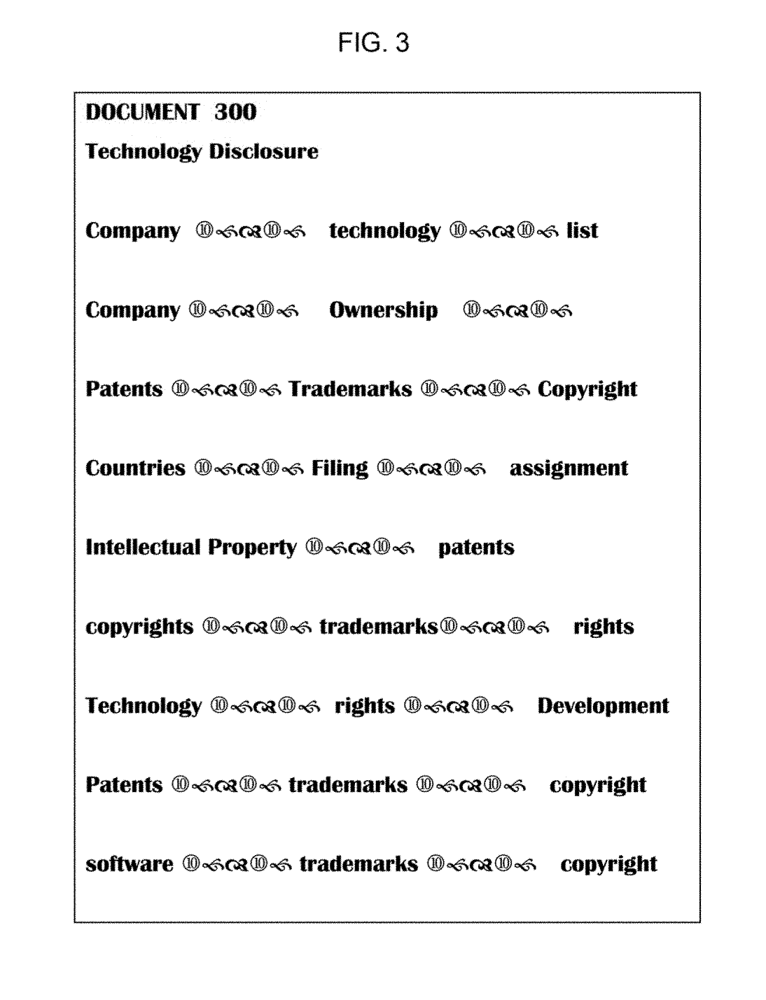

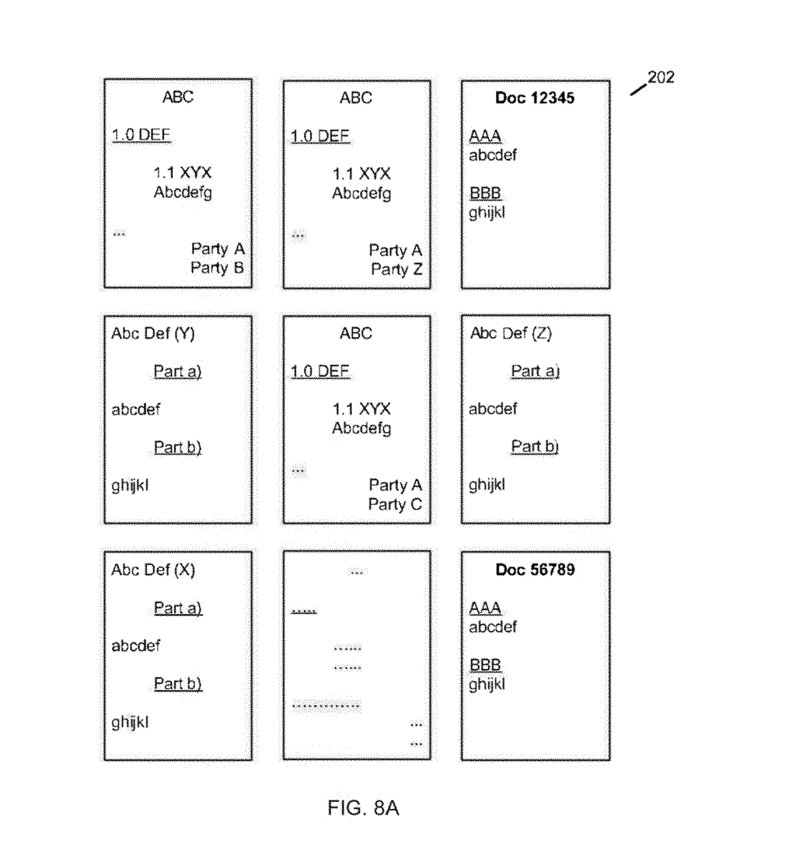

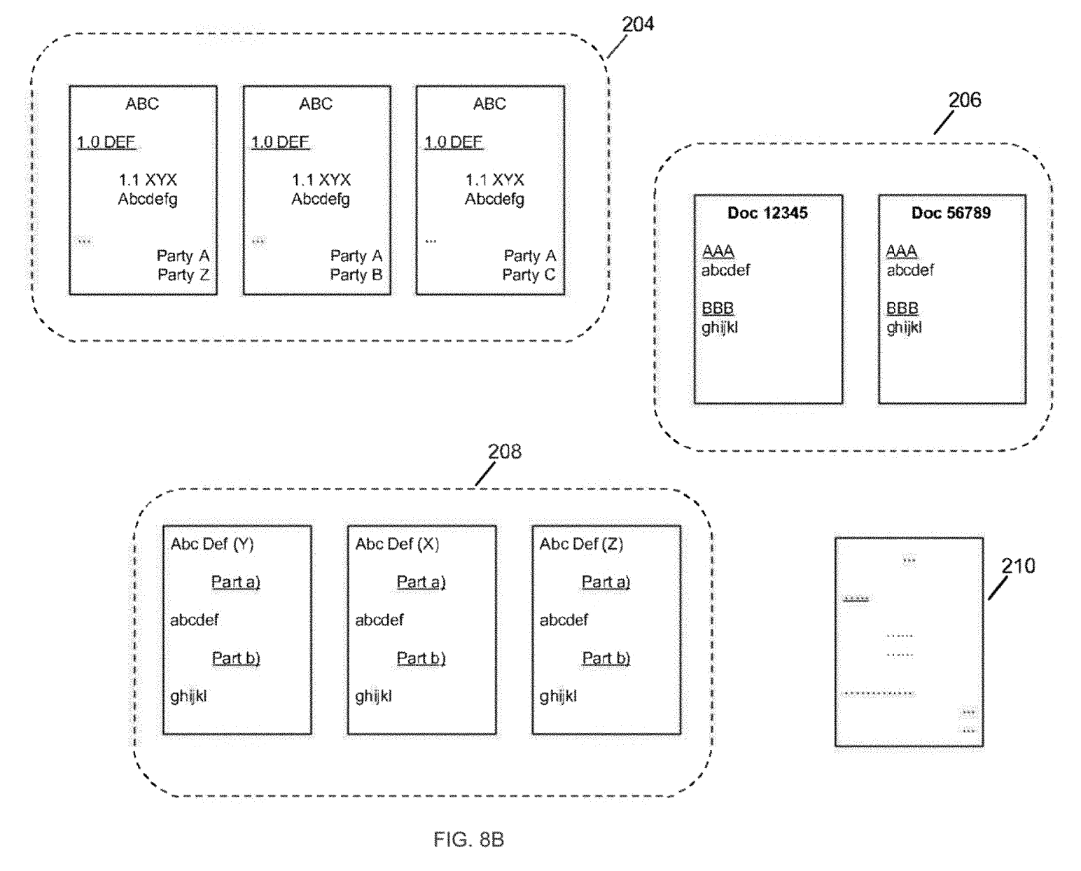

FIGS. 8A and 8B show another example where all documents 302 relate generally to real-estate transactions. A first run of the algorithm for clustering may show that the global average distance metric is fairly low and the clusters generated may not be granular enough. A user may then be able to manually set the distance metric required for documents to be considered to be within the same cluster and then rerun the algorithm. In this manner applying the clustering as herein described results in a more granular result. Accordingly, the result shown in FIG. 3B may be arrived at where the documents in cluster 304 are all real-estate transaction documents; for example by having noted a high frequency of the features “purchase” and “sale” 306; and a separate cluster of anomalous documents is generated which includes a property listing, land survey and tax documents related to the transaction. Of course, if there are a plurality of listing, survey and tax documents, each of these plurality of groups of documents would be clustered together.

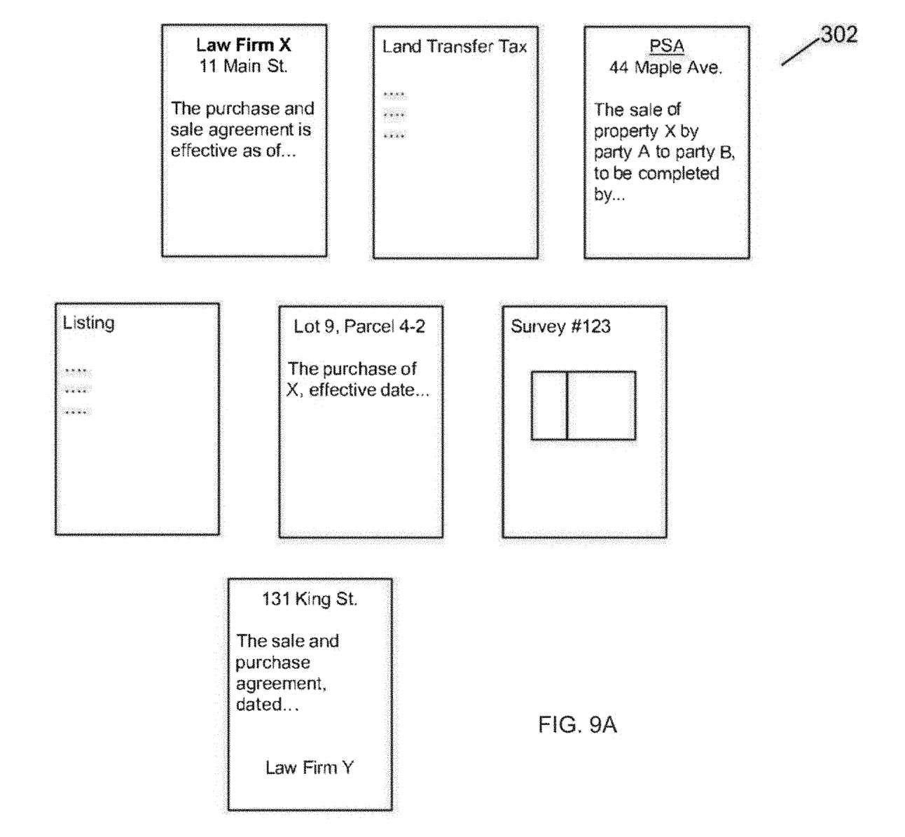

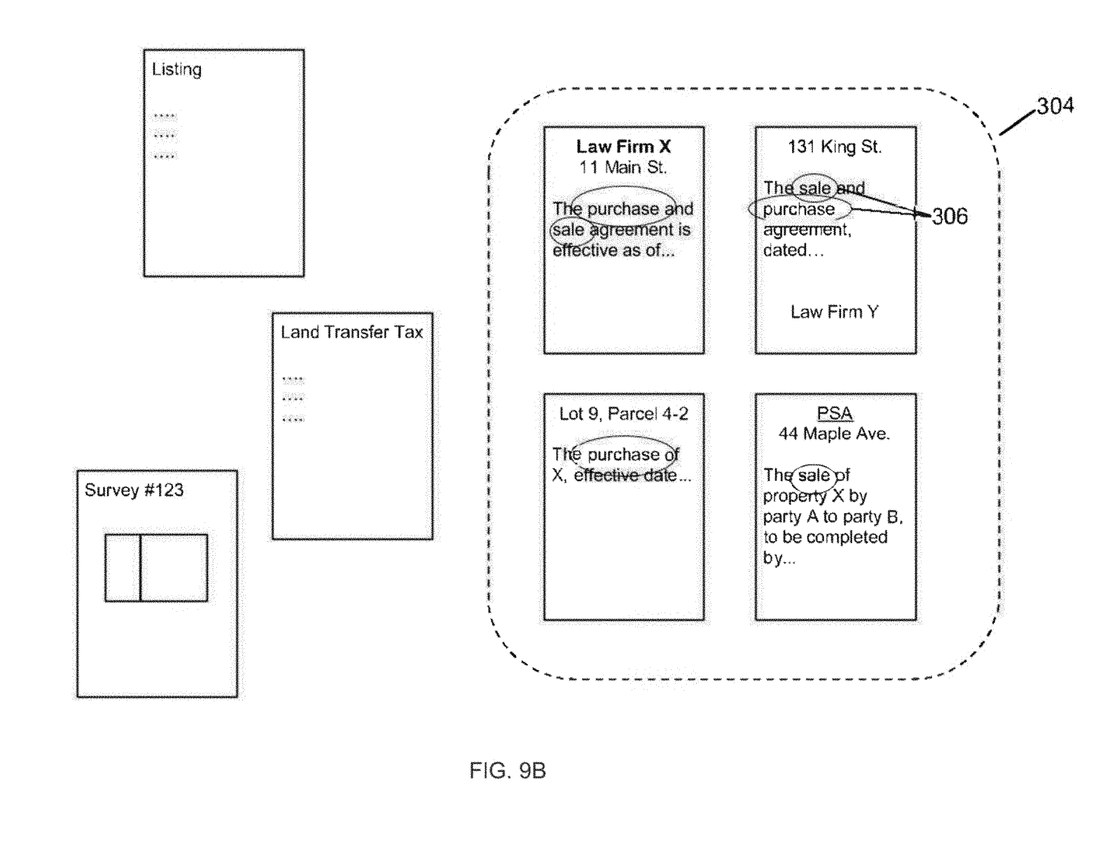

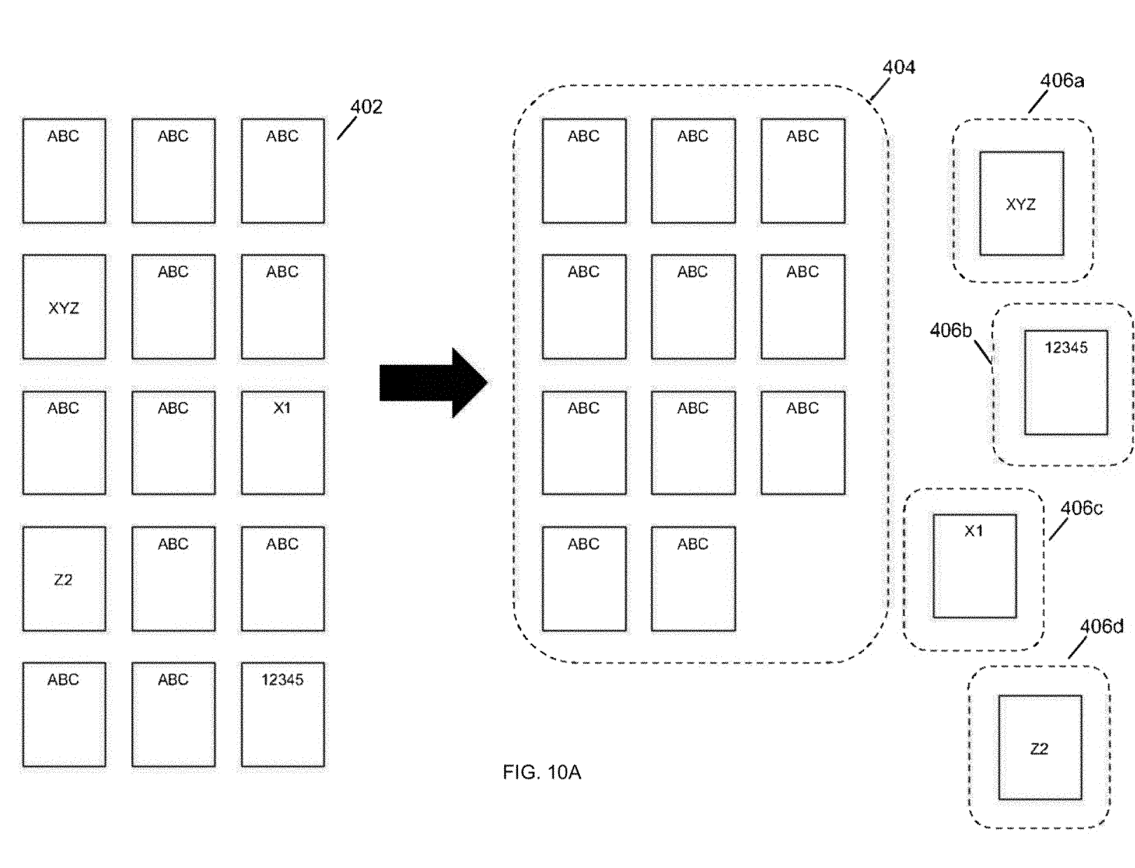

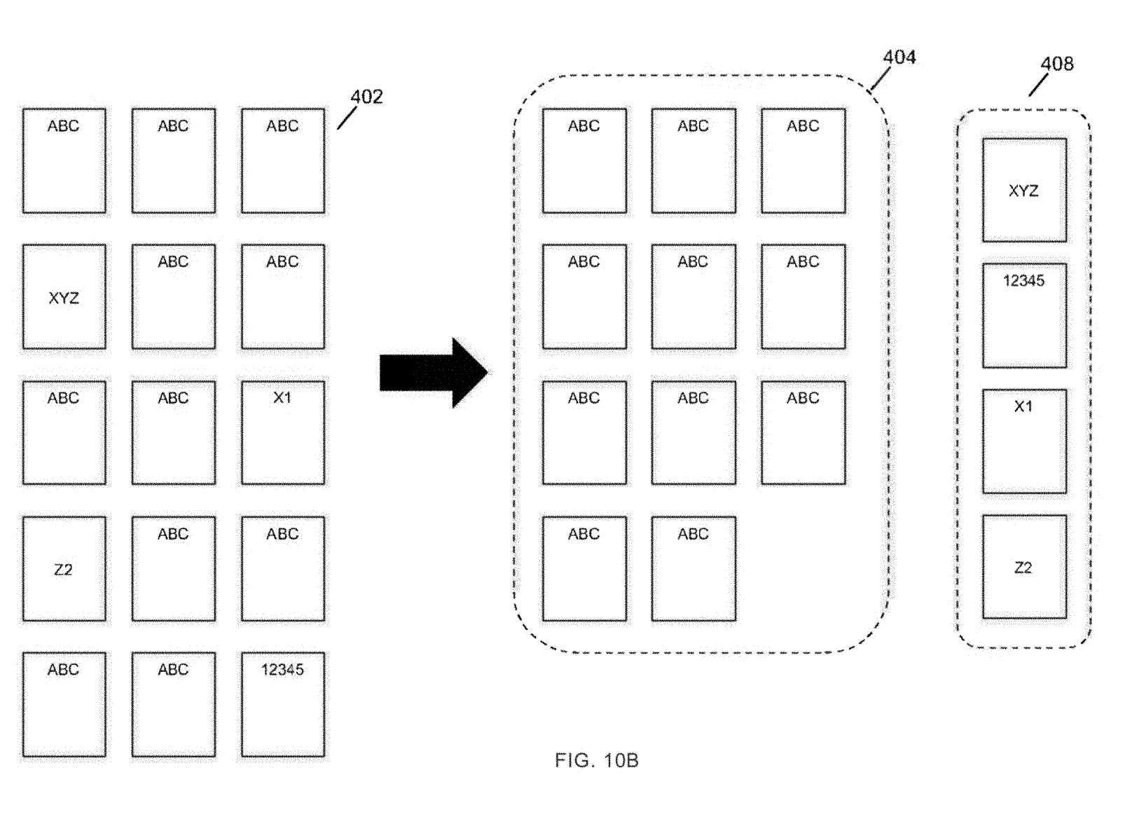

FIGS. 9A and 9B illustrate two different ways in which anomalous clusters may be treated. In FIG. 9A, a plurality of documents out of the set 402 have been clustered together as cluster 404. In addition, a number of other documents whose distance metrics were determined to be far too divergent have been clustered individually as separate clusters 406a-406d. The result in this example is a total of five clusters. FIG. 9B on the other hand shows a different way of clustering the same set of documents 402, where the anomalous documents as a group have been clustered together in cluster 408. The cluster 408 could be determined to be a cluster of anomalous documents by a user without actually opening an single document. This could be done by the statistical analysis referred to earlier, whereby the average distance metric in cluster 408 would be significantly higher than the average distance metric between documents in cluster 404. For example, on concluding the clustering, the average distance metric in cluster 404 could be in the range of approximately 2-4; whereas the average distance metric of documents in cluster 408 could be in the range of 5-100, with these figures identified for illustrative purposes only.

Following the cluster generation, a user may need to only review one or two documents from any given cluster and have confidence that all documents in the cluster are of a certain document type. The user may then mark each cluster appropriately or assign review tasks to particular users for each cluster. It will be apparent to one skilled in the art that with this process, only a small subset of documents require initial user review or categorization before a large dataset of documents can be categorized. For example, with respect to the example shown in FIGS. 8A and 8B, a user would only need to review a single document in cluster 304 to determine that all documents in the cluster are purchase and sale agreements with respect to the real-estate transaction. A decision could then be made on what action is required to be taken with respect to purchase and sale documents.

In one alternative, the clusters could be stored on a computer-readable medium and subsequently accessed by downstream software which attempts to characterize the documents. Various software tools exist which attempt to characterize documents as being of a particular type. For example, software could be used which determines that the features “purchase” and “sale” are found in the headings or most relevant paragraphs of the documents shown in FIGS. 8A and 8B and subsequently provide a suggestion that these are purchase and sale documents related to a real-estate transaction. Prior art systems which accomplish this are often highly processor intensive and can take significant computing time and resources to run. However, having grouped the documents into clusters as herein described, the downstream software may only be required to review a small subset of documents within each cluster to provide a suggestion as to the content or type of document present in the entire cluster.

It will be apparent to one of skill in the art that other configurations, hardware etc. may be used in any of the foregoing embodiments of the products, methods, and systems of this invention. It will be understood that the specification is illustrative of the present invention and that other embodiments within the spirit and scope of the invention will suggest themselves to those skilled in the art.

The aforementioned embodiments have been described by way of example only. The invention is not to be considered limiting by these examples and is defined by the claims that now follow.

What is claimed is:

1. A method for clustering electronic documents comprising:
identifying a plurality of electronic documents stored on a computer readable medium;
determining by a computer processor a distance metric between each document in said plurality of electronic documents;
grouping by the computer processor one or more documents from said plurality of electronic documents into clusters based on a maximum permissible distance metric between documents within a cluster.

2. The method according to claim 1, wherein the step of determining a distance metric is agnostic to the literal content of each document.

3. The method according to claim 1, wherein the step of determining a distance metric comprises determining a cumulative frequency of individual features between each document and comparing the cumulative feature frequencies of each pair of documents to arrive at the distance metric.

4. The method according to claim 3, wherein features are one or more selected from the group consisting of words, typography, grammar and syntax.

5. The method according to claim 1, further comprising outputting cluster data to a computer readable medium and inspecting a single document within each cluster to categorize the cluster as a whole as containing a specific type of document.

6. The method according to claim 5, wherein the inspecting is by a user or by a computer processor executing a categorization algorithm.

7. The method according to claim 5, further comprising grouping clusters having only a single document based on the maximum permissible distance metric into a cluster of anomalous documents which do not conform to the maximum permissible distance metric.

8. The method according to claim 7, wherein said cluster of anomalous documents is categorized as containing uncategorized documents and queued for individual categorization of each document within the cluster of anomalous documents.

9. The method according to claim 1, wherein the cumulative feature frequency is based on a pre-determined subset of features in each electronic document.

10. The method according to claim 9, wherein the pre-determined subset omits one or more features selected from the group consisting of document words, word syntax, word grammar and typographical standard to the subject matter of the plurality of documents.

11. The method according to claim 10, wherein the omitted features are determined by the computer processor from a database of predefined omitted features stored on a computer readable medium.

12. A system for clustering electronic documents comprising:
a computer readable medium having computer executable instructions stored thereon, which when executed by a computer processor
identifies a plurality of electronic documents stored on a computer readable medium;
determines a distance metric between each document in said plurality of electronic documents;
groups one or more documents from said plurality of electronic documents into clusters based on a maximum permissible distance metric between documents within a cluster.

13. The system according to claim 12, wherein the distance metric determination is agnostic to the literal content of each document.

14. The system according to claim 12, wherein the determining of a distance metric comprises determining a cumulative frequency of individual features between each document and comparing the cumulative feature frequencies of each pair of documents to arrive at the distance metric.

15. The system according to claim 14, wherein features are one or more selected from the group consisting of words, typography, grammar and syntax.

16. The system according to claim 12, wherein the computer executable instructions further include instructions for outputting cluster data to a computer readable medium for the purpose of inspecting a single document within each cluster to categorize the cluster as a whole as containing a specific type of document.

17. The system according to claim 16, wherein the outputting of cluster data is in a format suitable for inspecting by a user or by a computer processor executing a categorization algorithm.

18. The system according to claim 16, wherein the computer executable instructions further include instructions for grouping clusters having only a single document based on the maximum permissible distance metric into a cluster of anomalous documents which do not conform to the maximum permissible distance metric.

19. The system according to claim 18, wherein said cluster of anomalous documents is categorized as containing uncategorized documents and queued for individual categorization of each document within the cluster of anomalous documents.

20. The system according to claim 12, wherein the cumulative feature frequency is based on a pre-determined subset of features in each electronic document.

21. The system according to claim 20, wherein the pre-determined subset omits one or more features selected from the group consisting of pronouns, adjectives and features common to the subject matter of the plurality of documents.

22. The system according to claim 21, wherein the omitted features are determined by the computer processor from a database of predefined omitted features stored on a computer readable medium.
